(19) United States
(12) Patent Application Publication
(10) Pub. No.: US 2015/0130984 A1
(43) Pub. Date: May 14, 2015

(54) ELECTRONIC DEVICE INCLUDING AN IMAGE SENSOR

(71) Applicant: Samsung Electronics Co., Ltd., Gyeonggi-do (KR)

(72) Inventor: Chae-Hoon LIM, Seoul (KR)

(21) Appl. No.: 14/528,210

(22) Filed: Oct. 30, 2014

(30) Foreign Application Priority Data
Nov. 13, 2013 (KR) 10-2013-0137767

(51) Int. Cl. H04N 5/232; H04N 5/225

(52) U.S. Cl. CPC H04N 5/232; H04N 5/2253
USPC 348/335

(57) ABSTRACT

An electronic device includes: a detachable lens module including at least one lens, and a shutter module disposed beneath the lens module and including an openable shutter. An imaging module is disposed beneath the shutter module and converts light imaged by the lens module and the shutter module to an electrical signal. A sensor module outputs a detection signal in response to attachment or detachment of the lens module; and a control module outputs a control signal for opening or closing the shutter to the shutter module in response to the detection signal. Also, other various exemplary may be implemented.

### CLAIM OF PRIORITY

This application claims priority under 35 U.S.C. §119 from Korean patent application No. 10-2013-0137767 filed Nov. 13, 2013 in the Korean Intellectual Property Office, the contents of which are incorporated herein by reference in its entirety.

### BACKGROUND

1. Field of the disclosure

The present disclosure relates to an electronic device including an image sensor.

2. Description of the Related Art

The development of the electronic communication industry has resulted in the proliferation of electronic devices, and more particularly portable electronic devices such as a cellular phone, a smartphone, an electronic notepad, a personal digital assistant (PDA), a laptop computer, and various types of mobile terminals. Such electronic devices have become necessary articles of modern life and have become an important means for delivering information which changes rapidly. Such electronic devices have provided a convenient work environment through a graphical user interface environment using a touchscreen to a user and various web-based multimedia.

Recently, most portable electronic devices have included camera modules providing an image capturing function as basic function. In the case of a mobile terminal, which is easily carried by a user, rapid image capture of a desired moment is now possible. However, the camera modules often include components such as an image sensor, and such components can be susceptible to degradation or damage from foreign substances.

### SUMMARY

The present disclosure has been made to address at least the above problems and disadvantages, and to provide at least the advantages described below. Accordingly, an aspect of the present disclosure is to provide an electronic device which prevents contaminants from degrading or damaging an image sensor when a lens module is detached from the electronic device, and a method for operating the electronic device.

Another aspect of the present disclosure is to provide an electronic device which prevents foreign substances such as contaminants from entering the electronic device when a lens module is detached from the electronic device and a method for operating the electronic device.

In accordance with another aspect of the present disclosure, an electronic device may include: a detachable lens module including at least one lens; a shutter module disposed beneath the lens module and including a reclosable shutter; an imaging module, disposed beneath the shutter module, for converting light imaged by the lens module and the shutter module to an electrical signal; a sensor module for outputting a detection signal in response to attachment or detachment of the lens module; and a control module for outputting a control signal for opening or closing the shutter to the shutter module in response to the detection signal.

In accordance with another aspect of the present disclosure, an electronic device may include: a lens module including at least one lens; a shutter module disposed beneath the lens module and including a reclosable shutter; an imaging module, disposed beneath the shutter module, for converting light imaged by the lens module and the shutter module to an electrical signal; and a control module for in response to a power-off signal outputting a control signal for closing the shutter to the shutter module and performing a power-off operation.

In accordance with still another aspect of the present disclosure, a method for operating an electronic device including an image sensor for imaging may include: detecting at least one event associated with protection of the image sensor; and opening or closing a shutter in response to the at least one event, wherein a light guide of the image sensor is opened or closed depending on whether the shutter is opened or closed.

In accordance with yet another aspect of the present disclosure, a method for operating an electronic device including an image sensor for imaging may include: outputting, by a sensor module, a detection signal corresponding to detachment of a lens module including at least one lens; outputting, by a control module, a control signal in response to the detection signal; and closing in response to the control signal, by a shutter module, a shutter.

In accordance with still another aspect of the present disclosure, a method for operating an electronic device including an image sensor for imaging may include: outputting, by a user input module, a power-off signal; outputting, by a control module, a control signal in response to the power-off signal; and in response to the control signal closing, by a shutter module, a shutter.

Before undertaking the DETAILED DESCRIPTION below, it is advantageous to set forth definitions of certain words and phrases used throughout this patent document: the terms “include” and “comprise,” as well as derivatives thereof, mean inclusion without limitation; the term “or,” is inclusive, meaning “and/or”; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” refers to any device, system or part thereof that controls at least one operation. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of an electronic device according to various embodiments of the present disclosure;

FIG. 2 and FIG. 3 illustrate from and rear perspective views of an electronic device according to various embodiments of the present disclosure;

FIG. 4 is a diagram illustrating an electronic device from which a lens module is detached, according to various embodiments of the present disclosure;

FIG. 5 illustrates a block diagram of a configuration of a camera device to various embodiments of the present disclosure;

FIG. 6 is a flowchart illustrating exemplary operation of a process of operating a camera device according to various embodiments of the present disclosure;

FIG. 7 is a flowchart illustrating exemplary operation of a process of operating a camera device according to various embodiments of the present disclosure; and

FIG. 8, FIG. 9, FIG. 10, FIG. 11 and FIG. 12 are flowcharts illustrating various processes of controlling a camera device according to various embodiments of the present disclosure.

### DETAILED DESCRIPTION

The following description with reference to the accompanying drawings is provided to assist the artisan with a comprehensive understanding of embodiments of the disclosure as defined by the claims and their equivalents. The description includes various specific details to assist in that understanding but these are to be regarded as merely non-limiting examples. Accordingly, those of ordinary skill in the art will recognize that various changes and modifications of the embodiments described herein can be made without departing from the spirit of the disclosure and scope of the appended claims. In addition, descriptions of well-known functions and constructions may be omitted for clarity and conciseness.

The terms and words used in the following description and claims are not limited to their dictionary meanings, but, are merely used to enable a clear and consistent understanding of the disclosure as would be understood by a person of ordinary skill in the art. Accordingly, it should be apparent to those skilled in the art that the following description of embodiments of the present disclosure is provided for illustration purposes only and not for the purpose of limiting the appended claims and their equivalents.

An artisan is to understand that the singular forms “a,” “an,” and “the” include plural referents unless the context clearly dictates otherwise. Thus, for example, reference to “a component surface” includes reference to one or more of such surfaces.

By the term “substantially” an artisan is to understand that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

An electronic device according to various embodiments of the present disclosure may be a device having a communication function, and such communication may be wireless. Examples of the electronic device may include at least one of a smart phone, a tablet personal computer, a mobile phone, a video phone, an e-book reader, a desktop personal computer, a personal digital assistant (PDA), a portable multimedia player (PMP), a MP3 player, mobile medical equipment, a camera, or a wearable device (for example, a head-mounted-device (HMD) such as an electronic glasses, an electronic clothing, an electronic bracelet, an electronic necklace, an electronic accessory, or a smart watch).

In some embodiments, the electronic device may be a smart home appliance having a communication function. The smart home appliance, for example, the electronic device may include at least one of a television, a digital video desk (DVD) player, a stereo, a refrigerator, an air-conditioner, a cleaner, an oven, a microwave oven, a washing machine, an air cleaner, a set-top box, a TV box (for example, Samsung HomeSync™, Apple TV™, or Google TV™), a game console, an electronic dictionary, a camcorder, or a digital photo frame, just to name a few non-limiting examples.

In some embodiments, the electronic device may include at least one of various types of medical equipments (for example, MRA (magnetic resonance angiography), MRI (magnetic resonance imaging), CT (computed tomography), an imaging device, or an ultrasonic imaging device), just to name a few non-limiting possibilities. In addition, the electronic device may include a navigation device, a GPS receiver, an event data recorder (EDR), a flight data recorder (FDR), a vehicle infotainment device, a ship electronic equipment (for example, a ship navigation device or a gyro-compass device), an avionics device, and/or a security equipment, just to name a few non-limiting possibilities.

In some embodiments, the electronic device may include at least one of a furniture, a portion of a building/structure, an electronic board, an electronic signature receiving device, a projector, and/or various types of meters (for example, water, electricity, gas, or radio wave), each of which has a communication function. The electronic device according to various embodiments of the present disclosure may be a combination of one or more of the above-described devices. In addition, those skilled in the art can appreciate that the appended claims are not limited to the various embodiments discussed in the present disclosure.

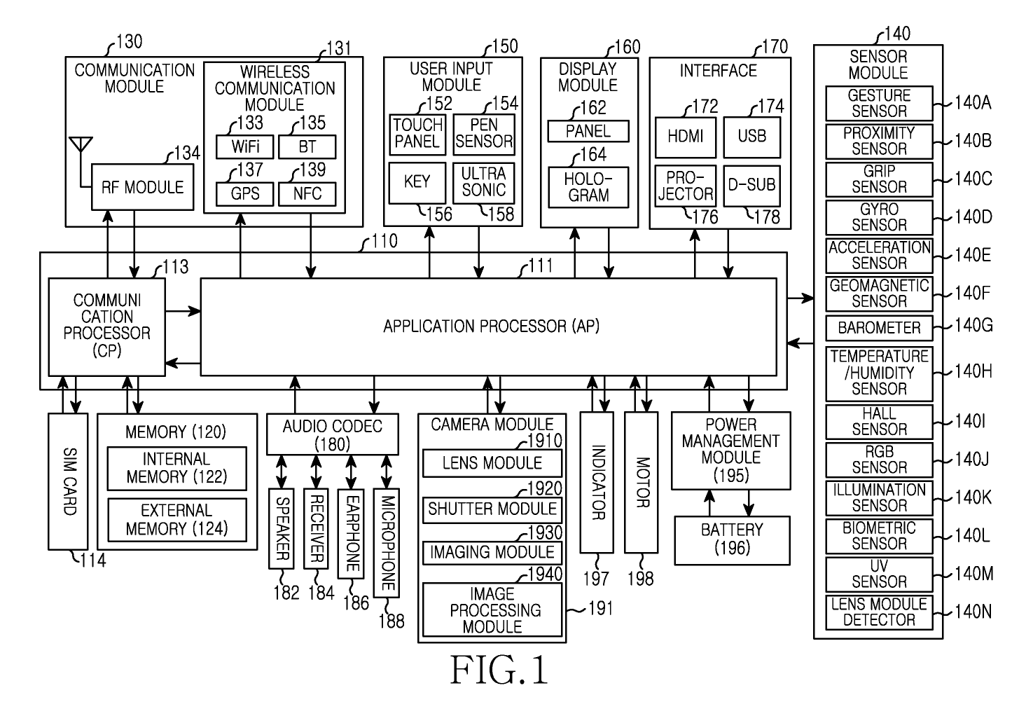

FIG. 1 illustrates a block diagram of an electronic device according to various embodiments of the present disclosure. An artisan should understand and appreciate that the block diagram of the electronic device is provided for explanatory purposes and the appended claims are not limited to the block diagram shown and described herein.

Referring now to FIG. 1, the electronic device 100 may include at least one processor 110, a subscriber identification module (SIM) card 114, a non-transitory memory 120, a communication module 130, a sensor module 140, a user input module 150, a display module 160, an interface 170, an audio codec 180, a camera module 191, a power management module 195, a battery 196, an indicator 197, or a motor 198.

The processor unit 110, which comprises hardware circuitry, may include at least one application processor (AP) 111 or at least one communication processor (CP) 113. Although the AP 111 and the CP 113 are illustrated as being included in the processor 110, the AP 111 and the CP 113 may be arranged apart therefrom. such as being included in different IC packages respectively. The AP 111 and the CP 113 may be included in one IC package.

The AP 111 may execute an operating system and an application program to control a plurality of hardware or software elements connected to the AP 111. Also, the AP 111 may perform data processing and data operation on various types of data including multimedia data. The AP 111 may be implemented using, for example, a system on chip (SoC). The processor 110 may further include a graphics processing unit (GPU) (not illustrated).

The CP 113 may manage data links for communication between the electronic device 100 and, for example, other electronic devices connected to the electronic device 100 through networks and convert a communication protocol. The CP 113 may be implemented using, for example, a SoC. The CP 113 may perform at least one of multimedia control functions. The CP 113 may also perform terminal identification and authentication within a communication network by using, for example, a subscriber identification module (for example, the SIM card 114). The CP 113 may provide services, such as a voice call service, a video call service, a short message service (SMS) message, or packet data, to a user.

The CP 113 may control data transmission and reception of the communication module 130. Although the components, such as the CP 113, the power management module 195, or the memory 120, are illustrated as being provided separately from the AP 111 in FIG. 1, the AP 111 may be implemented to include at least one (for example, the CP 113) of the above-described elements.

The AP 111 or the CP 113 may load a command or data received from at least one of a nonvolatile memory or another component connected to the AP 111 or the CP 113 into a volatile memory and process the same. The AP 111 or the CP 113 may store data received from or generated by at least one of other elements in the nonvolatile memory.

The SIM card 114 may be a card implementing a subscriber identification module and may be inserted into a slot formed at a specific position of the electronic device 100. The SIM card 114 may include unique identification information (for example, integrated circuit card identifier (ICCID)) or subscriber information (for example, international mobile subscriber identity (IMSI)).

The non-transitory memory 120 may include an internal memory 122 or an external memory 124. The internal memory 122 may include, for example, at least one of a volatile memory (for example, dynamic RAM (DRAM), a static RAM (SRAM), or a synchronous dynamic RAM (SDRAM)), or a non-volatile memory (for example, a one time programmable ROM (OTPROM), a programmable ROM (PROM), an erasable and programmable ROM (EPROM), an electrically erasable and programmable ROM (EEPROM), a mask ROM, a flash ROM, a NAND flash memory, NOR flash memory). The internal memory 122 may have the form of a solid state drive (SSD). The external memory 124 may further include, for example, a compact flash (CF) card, a secure digital (SD) card, a micro secure digital (Micro-SD) card, a mini secure digital (Mini-SD) card, an extreme digital (xD) card, or a memory stick, just to name a few non-limiting possibilities.

The communication module 130 may include a wireless communication module 131 or a radio frequency (RF) module 134, and hardware such as a transmitter, receiver, or transceiver. The wireless communication module 131 may include, for example, a WiFi module 133, a Bluetooth (BT) module 135, a global positioning system (GPS) module 137, and/or a near-field communication (NFC) module 139. For example, the wireless communication module 131 may provide a wireless communication function by using a radio frequency. Additionally, or alternatively, the wireless communication module 131 may include a network interface (for example, LAN card) or a modem which connects the electronic device 100 to a network (for example, Internet, local area network (LAN), wire area network (WAN), telecommunication network, cellular network, satellite network, or plain old telephone service (POTS)).

The RF module 134 may perform transmission and reception of data, for example, transmission and reception of wireless signals, such as RF signals or requested electronic signals. Although not illustrated, the RF module 134 may include, for example, a transceiver, a power amp module (PAM), a frequency filter, or a low noise amplifier (LNA). The RF module 134 may further include a component for transmitting and receiving electromagnetic waves in free space for wireless communication, for example, via a conductor or a conductive line.

With continued reference to FIG. 1, the sensor module 140 may include at least one of, for example, a gesture sensor 140A, a proximity sensor 140B, a grip sensor 140C, a gyro sensor 140D, an acceleration sensor 140E, a geomagnetic sensor 140F, a barometer 140G, a temperature/humidity sensor 140H, a Hall sensor 140I, a RGB (red-green-blue) sensor 140J, an illuminance sensor 140K, a biometric sensor 140L, an ultra violet (UV) sensor 140M, and a lens module detector 140N. The sensor module 140 may measure a physical amount or detect the operating state of hardware (for example, a lens module 1910) and convert measured or detected information to an electrical signal. Additionally/alternatively, the sensor module 140 may include, for example, an E-nose sensor (not illustrated), an electromyography (EMG) sensor (not illustrated), an electroencephalogram (EEG) sensor, (not illustrated), an electrocardiogram (ECG) sensor (not illustrated) or a fingerprint sensor. The sensor module 140 may further include a control circuit for controlling at least one sensor included therein.

With continued reference to FIG. 1, the user input module 150 may include a touch panel 152, a (digital) pen sensor (for example, digitizer) 154, a key 156, or an ultrasonic input device 158. The touch panel 152 may recognize a touch input using at least one method of, for example, a capacitive method, a resistive method, an infrared method, and an ultrasonic method. The touch panel 152 may further include its own controller (not illustrated). In the case of a capacitive method, not only direct touch, but also proximity recognition are possible. The touch panel 152 may further include a tactile layer. In this case, the touch panel 152 may provide a touch response to a user.

The (digital) pen sensor 154 may be implemented by using at least one of a capacitive method, a resistive method, an infrared method, and an ultrasonic method, which are identical or similar to those which may be used at a time of receiving a touch input of a user. For example, a keypad or a touch key may be used as the key 156. The ultrasonic input device 158 is a device for detecting a sound wave using a microphone and identifying data in a terminal, through a pen for generating an ultrasonic signal to enable wireless recognition. The electronic device 100 may receive a user input from an external device (for example, a network, a computer, or a server) connected thereto using the communication module 130.

The display module 160 may include, for example, a display panel 162 and a hologram 164. The panel 162 may be, for example, a liquid-crystal display (LCD) panel or an active-matrix organic light-emitting diode (AM-OLED) panel. The panel 162 may be implemented to be, for example, flexible, transparent, or wearable. The panel 162 and the touch panel 152 may be configured as one module. The hologram 164 may enable a 3D image to be viewed in space using optical interference. The display module 160 may further include a control circuit for controlling the panel 162 or the hologram 164.

The interface 170 may include, for example, a high-definition multimedia interface (HDMI) 172, a universal serial bus (USB) 174, a projector 176 or a D-subminiature (D-sub) 178. Additionally or alternatively, the interface 170 may include a secure digital (SD)/multi-media card (MMC) interface (not illustrated) or an infrared data association (IrDA) interface, just to name some non-limiting possible examples.

The codec 180 may perform conversion between voice and an electrical signal bi-directionally. The audio codec 180 may perform conversion of voice information input or output through, for example, a speaker 182, a receiver 184, an earphone 186, or a microphone 188.

The camera module 191 may capture a still image and/or moving images. The camera module 191 may include a lens module 1910, a shutter module 1920, an imaging module 1930, or an image processing module 1940, just to name some possibilities.

Although not illustrated, the lens module 1910 may also include at least one lens, a diaphragm module, an optical zoom module, an auto focusing module, or an optical image stabilization (OIS) module. The at least one lens may include a transparent object (for example, crystal or glass) for collecting or dispersing light. The diaphragm module is variably-sized, meaning that changes the diameter of a diaphragm occur under the control of the processor (for example, AP 111 or ISP) to regulate the amount of light incident to the image processing module 1930 (for example, an image sensor). The optical zoom module may decrease or increase a focal length of at least one lens under the control of the processor (for example, the AP 111 or ISP). The AF module may move at least one lens under the control of the processor (for example, the AP 111 or ISP) to focus on a subject. The OIS module may move at least one lens in a direction opposite to a movement direction of the camera module 1910 under the control of the processor (for example, the AP 111 or ISP) to cancel out the effects of hands shaking while capturing an image or images. The processor may control the OIS module in response to movement information (for example, a direction or an angle) obtained from the sensor module 140 (for example, the gyro sensor 140D). As another embodiment, the image sensor (not illustrated) may be moved for correction of hand shaking under the control of the processor. The lens module 1910 may include at least one filter (for example, an infrared blocking filter).

The shutter module 1920 may include, for example, an openable shutter (not illustrated), an integrated circuit (IC), and a motor. The shutter module 1920 may open or close the shutter by a motor that operates under the control of the IC. The shutter module 1920 may change a speed of the shutter (not illustrated) under the control of the processor (for example, the AP 111 or ISP) to regulate the amount of light incident to the imaging module 1930.

The imaging module 1930 (for example, the image sensor) converts light (an optical signal) imaged by the lens module 1910 and the shutter module 1920 to a digital form of an electrical signal. The imaging module 1930 is used generate image data for each pixel.

In addition, the image processing module 1940 may include an image signal processor (ISP). The image processing module 1940 may control the lens module 1910 or the shutter module 1920. The image processing module 1940 may change the color sense of obtained image data to be represented as an actual image and regulate brightness. For example, the image processing module 1940 may control automatic exposure (AE), automatic white-balance (AWB), and automatic focus (AF). In addition, the ISP may control the F-number of the diaphragm (a diameter of the diaphragm/a focal length of a lens) and a shutter speed by analyzing a frequency component of the image data and recognizing the resolution of an image. The image processing module 1940 may be arranged in the processor 110.

The electronic device 100 may include a housing (not illustrated) forming an exterior appearance of the electronic device. The housing may include a penetration portion, or simply an opening (not illustrated) that passes through between the outside and inside of the electronic device 100. The opening is disposed between the lens module 1910 and the imaging module 1930. The lens module 1910 may be disposed at an outer surface of the opening in the housing. The imaging module 1930 is disposed at an inner surface of the opening. The shutter module 1920 may be disposed within the opening or extending through the opening and being disposed between the lens module 1910 and the imaging module 1930. The shutter module 1920 could be arranged above or below the opening, but in any event, activation of the shutter serves to open or close a passage (for example, a light guide) of the opening under the control of the processor 110 (for example, the AP 111 or ISP). When the shutter of the shutter module 1920 is opened, light may be incident to the imaging module 1930 through the lens module 1910 and the opening. When the shutter of the shutter module 1920 is closed, light may not be incident to the imaging module 1930. The amount of light incident to the image processing module 1930 (for example, the image sensor) may be regulated according to the shutter speed associated with opening or closing of the shutter of the shutter module 1920.

The sensor module 140 may detect attachment or detachment of the lens module 1910 to or from the opening. The processor 110 (for example, the AP 111 or ISP) may identify the detachment of the lens module 1910 through the sensor module 140 and close the shutter through the control of the shutter module 1920 in response to the detachment. When the shutter of the shutter module 1920 is closed, the opening is closed by the shutter and is protected from external pollution sources (for example, dust or rain). The processor 110 (for example, the AP 111 or ISP) may identify the attachment (i.e. the presence) of the lens module 1910 through the sensor module 140 and open the shutter through the control of the shutter module 1920 in response to the attachment.

The processor 110 may output a control signal for opening or closing the shutter to the shutter module 1920 in response to the sensing of the attachment or detachment of at least one component (for example, the lens module 1910).

The processor 110 may output a control signal for closing the shutter to the shutter module 1920 in response to the occurrence of a power-off signal, even when the lens module 1910 is still attached. The power-off signal may be output to the user input module 150 (for example, the key 156).

In response to switching to a sleep mode, the processor 110 may output a control signal for closing the shutter to the shutter module 1920 to keep the opening protected when not being used. The sleep mode may refer to a mode in which the supply of power to at least one component is blocked when the electronic device 100 is not used for a predetermined period of time. The sleep mode may reduce power consumption by blocking the supply of power to at least one component. For example, the sleep mode may turn off a screen (for example, the display module 160).

The processor 110 may output a control signal for closing the shutter to the shutter module 1920 in response to occurrence of an external shock. The external shock may be detected by the sensor module 140, or by another sensor that senses vibration, (for example if dropped).

The processor 110 may output a control signal for closing the shutter to the shutter module 1920 in response to occurrence of shutdown. The shutdown may include the suspension of operation of the electronic device 100 due to, for example, failure, accident, or other errors.

The power management module 195 may apply a normal power or a standby power or a regular power (a regularly available i.e. fully functional power level) to the sensor module 140 and/or the shutter module 1920. The regular power may be a battery power or a power obtained by regulating the battery power. Although the electronic device 100 is in the sleep mode, the sensor module 140 may be driven by using the regular power. When the sensor module 140 detects detachment of the lens module 1910 in the sleep mode, the processor 110 (for example, the AP 111 or ISP) may switch from the sleep mode to a wake-up mode and output a control signal for closing the shutter to the shutter module 1920. The shutter module 1920 may close the shutter in response to the control signal from the processor 110. When the sensor module 140 detects attachment of the lens module 1910 in the sleep mode, the processor 110 (for example, the AP 111 or ISP) may switch from the sleep mode to the wake-up mode and output a control signal for opening the shutter to the shutter module 1920. The shutter module 1920 may open the shutter in response to the control signal from the processor 110. The processor 110 (for example, the AP 111) may switch to the sleep mode again.

With continued reference to FIG. 1, the electronic device 100 may include a microcontroller unit (MPU) (not illustrated) with which the processor 110 (for example, the AP 111) may be substituted. The microcontroller unit may reduce load of the processor 110 and power consumption. The microcontroller unit may control a control signal associated with opening/closing of the shutter in response to a signal from the sensor module 140 to the shutter module 1920, independently from the processor 110. In other words, while the processor 110 remains in a sleep mode, the microcontroller can control the shutter, and the power usage by the microcontroller may be much less than operation of the processor 110.

The power management module 195 includes hardware configured to manage power of the electronic device 100. Although not illustrated, the power management module 195 may include, for example, a power management integrated circuit (PMIC), a charger integrated circuit (IC), or a battery fuel gauge. The PMIC may be mounted within, for example, an integrated circuit or a SoC semiconductor. A charging method may include a wired charging method and a wireless charging method. The charger IC may charge a battery and prevent the application of overvoltage or overcurrent from a charger. The charger IC may include a charger IC employing at least one of a wired charging method or a wireless charging method. The wireless charging method may include, for example, a magnetic resonance method, a magnetic induction method, or an electromagnetic wave method, just to name some non-limiting possibilities. For example, an additional circuit for wireless charging, for example, a coil loop, a resonance circuit, or a rectifier may be included.

The battery fuel gauge may measure, for example, an amount of power remaining, or a voltage, a current, or a temperature of the battery 196 during charging. The battery 196 may generate electricity and supply power and may be, for example, a rechargeable battery.

The indicator 197 may indicate a specific state of the electronic device 100 or an element thereof (for example, the AP 111), for example, a booting state, a message state, or a charging state. The motor 198 may convert an electrical signal to mechanical vibration. Although not illustrated, a micro control unit (MCU) may control the sensor module 140. An artisan should also appreciate a piezoelectric device could also provide vibration based on a received electrical signal.

Although not illustrated, the electronic device 100 may also include other types of processing devices (for example, a graphical processing unit (GPU)) for supporting mobile TV services. The processing device for supporting mobile TV services may process media data compliant with a standard, such as digital multimedia broadcasting (DMB), digital video broadcasting (DVB), or media flow.

The names of the above-described elements of the electronic device according to an embodiment may vary depending on a type of the electronic device. According to an embodiment, the electronic device 100 may be configured by including at least one of the above-described elements, and some element or elements may be omitted from the electronic device, or an additional element or elements may be further included in the electronic device. In addition, some of the elements of the electronic device according to the embodiment may be combined into one entity and perform functions of relevant elements before combination.

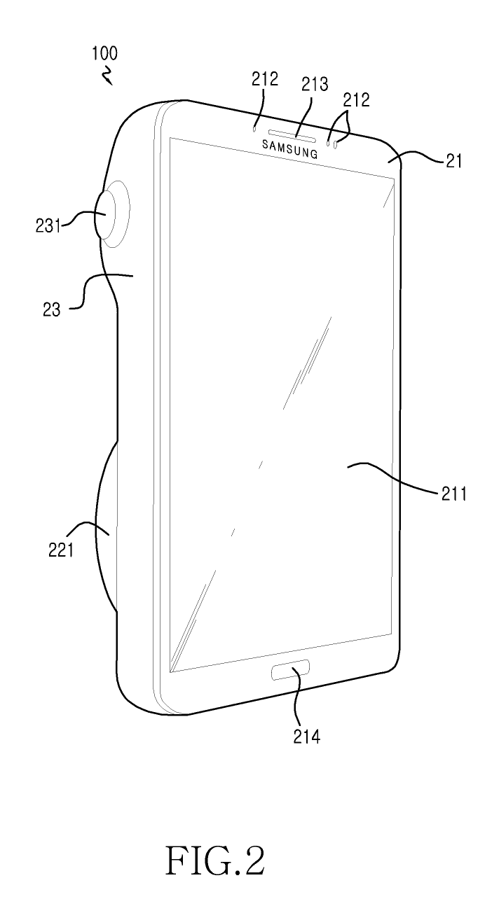

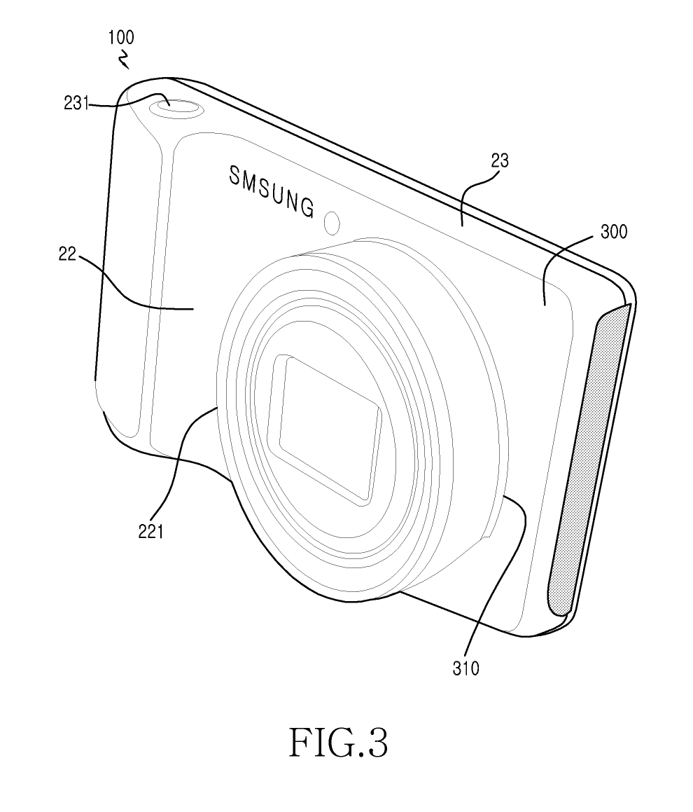

FIGS. 2 and 3 illustrate perspective views of an electronic device according to various embodiments of the present disclosure. FIG. 2 shows a front of the electronic device and FIG. 3 shows a rear of the electronic device.

Referring now to FIGS. 2 and 3, the electronic device 100 may include a touchscreen 211 (for example, the panel 162 and the touch panel 152 shown in FIG. 1) disposed at the front surface 21 of the electronic device, a plurality of sensors (for example, the sensor module 140), a speaker 213 (for example, the speaker 182), or a key button 214 (for example, the key 156).

As shown in FIG. 3, the electronic device 100 may include a lens module 221 (for example, the lens module 1910) disposed at the rear surface 22 of the electronic device. The lens module 221 may be detachably attached to the electronic device. The lens module 221 may be mounted in a lens module mounting portion 310 formed in an outer portion (housing 300) of the electronic device 100. The electronic device 20 may include a capture button 231 disposed at an outer surface 23 of the electronic device. The capture button instructs the camera to capture the current image.

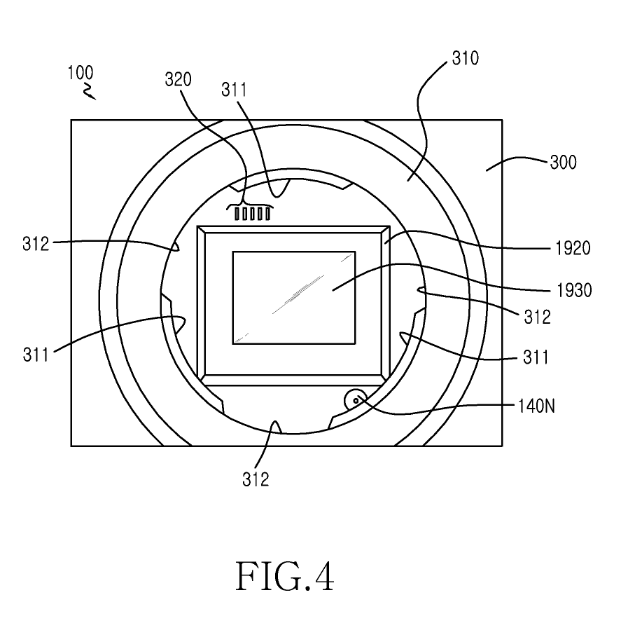

FIG. 4 illustrates a section of the rear of an electronic device 100 from which a lens module 221 is detached, according to various embodiments of the present disclosure. Referring to FIG. 4, the electronic device 100 may include a housing 300, an opening 310 in the housing, a plurality of terminals 320, a lens module detector 140N, a shutter module 1920, or an imaging module 1930.

The housing 300 may form an outer surface of the electric device, or simply provide an elegant appearance, of the electronic device 100.

The opening 310 may be formed in the housing 300 and may pass through between the outside and inside of the electronic device 100. The opening 310 may include a plurality of projections 311 disposed in or along an inner rim of the opening. A plurality of grooves 312 may be disposed between the plurality of projections 311. The lens module 1910 (not illustrated) may engage with an engaging portion 310 in such a way as to insert at least a portion of the lens module 310 into the opening 310 and permit rotation of the lens module 310. The lens module 1910 may include a plurality of grooves (not illustrated) having passages that guides the plurality of projections 311 of the opening 310 at an end of the lens module.

The plurality of terminals 320 may be disposed in the opening 310. The lens module 1910 may be electrically connected to the plurality of terminals 320. The plurality of terminals 320 may be electrically connected to a main circuit board (e.g., a main board or a mother board) (not illustrated). The main circuit board is a board on which a basic circuit and a plurality of electronic components are mounted. The main circuit board may set an execution environment of the electronic device 100, maintain information thereof, and allow the electronic device 100 to be stably driven. The main circuit board may allow all units of the electronic device to smoothly perform data input/output exchange. The plurality of terminals 320 may be mounted on the main circuit board. The plurality of terminals 320 may be electrically connected to the main circuit board through an electrical connection member (for example, a cable or a flexible printed circuit board (FPCB)). The plurality of terminals 320 may be a portion having elasticity (for example, a pogo pin or an elastic member).

The lens module detector 140N may be disposed in the opening 310. The lens module detector 140N may be electrically connected to the main circuit board through an electrical connection member (for example, a cable or a FPCB). The lens module detector 140N may generate a signal associated with attachment or detachment of the lens module 1910 (not illustrated). For example, the lens module detector 140N may include a push-button switch (not illustrated), or some other type of switch. When the lens module 1910 is attached to the opening 310, the push-button switch of the lens module detector 140N may be pushed by the lens module 1910 to generate a relevant signal. When the lens module 1910 is detached from the opening 310, the push-button switch of the lens module detector 140N may be released from a pushed-in state to generate a relevant signal.

The shutter module 1920 may be disposed beneath the lens module 1910 (not illustrated) and above the imaging module 1930. The opening 310 of the housing 300 may be disposed between the lens module 1910 (not illustrated) and the imaging module 1930. The shutter module 1920 may be electrically connected to the main circuit board (for example, the control module) (not illustrated) through an electrical connection member (for example, a cable or a FPCB). The shutter module 1920 may open or close a shutter (not illustrated) under the control of the main circuit board. The shutter module 1920 may open or close the light guide of the opening 310 depending on whether the shutter is opened or closed.

The imaging module 1930 (for example, the image sensor) may be disposed beneath the shutter module 1920. The imaging module 1930 may be mounted on the main circuit board (not illustrated). The imaging module 1930 may be electrically connected to the main circuit board through an electrical connection member (for example, a FPCB). When the shutter module 1920 closes a light guide of the opening 310, the imaging module 1930 may be protected from the outside.

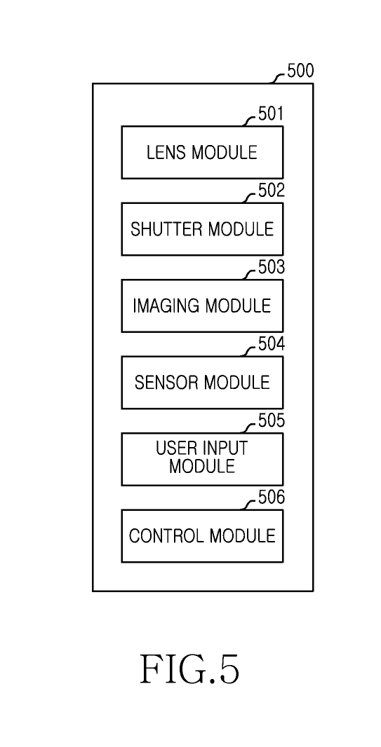

FIG. 5 illustrates a block diagram of a configuration of a camera device according to various embodiments of the present disclosure. Referring now to FIG. 5, the camera device 500 shown in this illustration may include a lens module 501, a shutter module 502, an imaging module 503, a sensor module 504, a user input module 505 and a control module 506. None of the aforementioned modules are pure software, or software per se and all comprise one or more hardware components such as circuits.

The lens module 501 (for example, the lens module 1910) may include at least one lens (not illustrated) and be detachably attached to the camera device.

The shutter module 502 (for example, the shutter module 1920) may be disposed beneath the lens module 501 and may include an openable shutter.

The imaging module 503 (for example, the imaging module 1930) may be disposed beneath the shutter module 502 and may convert light imaged by the lens module 501 and the shutter module 502 to an electrical signal.

The sensor module 504 (for example, the sensor module 140) may output a detection signal in response to attachment or detachment of the lens module 501.

The user input module 505 (for example, the user input module 150) may output an input signal (for example, a power-off signal) from a user.

The control module 506 (for example, the processor 110) may output a control signal for opening or closing the shutter in response to the detection signal from the sensor module 504.

In accordance with implementations of the present disclosure, an electronic device includes: a detachable lens module including at least one lens; a shutter module disposed beneath the lens module and including an openable shutter; an imaging module, disposed beneath the shutter module to convert light imaged by the lens module and the shutter module to an electrical signal; a sensor module configured to output a detection signal in response to sensing an attachment or detachment of the lens module; and a control module configured to output a control signal for opening or closing the shutter to the shutter module in response to the detection signal.

In accordance with implementations of the present disclosure, the control module may output the control signal for closing the shutter to the shutter module, in response to the detection signal corresponding to detachment of the lens module.

In accordance with implementations of the present disclosure, the control module may output the control signal for opening the shutter to the shutter module, in response to the detection signal corresponding to attachment of the lens module.

In accordance with implementations of the present disclosure, the electronic device may further include a housing providing an elegant external appearance of the electronic device and including an opening therein. The opening may be disposed at the rear of the device (but could also be at another side) between the lens module and the imaging module, and the shutter module may open and close a passage of the opening according to whether the shutter is opened or closed.

In accordance with implementations of the present disclosure, the sensor module may include a switch that is pushed-in or released according to whether the lens module is attached or detached.

In accordance with implementations of the present disclosure, the sensor module may be driven by a regular power.

In accordance with implementations of the present disclosure, the control module may switch from a sleep mode to a wake-up mode in response to the detection signal.

In accordance with implementations of the present disclosure, the lens module may further include a diaphragm for regulating an amount of light.

In accordance with another implementations of the present disclosure, an electronic device includes: a lens module including at least one lens; a shutter module disposed beneath the lens module and including an openable shutter; an imaging module, disposed beneath the shutter module configured to convert light imaged by the lens module and the shutter module to an electrical signal; and a control module configured to output a control signal for closing the shutter to the shutter module and performing power-off, in response to a power-off signal.

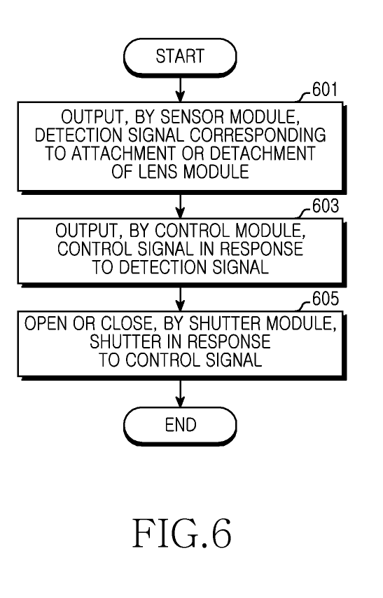

FIGS. 6-12 provide algorithms that disclose the functions performed by various modules (such as the control module, sensor module, etc.,) of the present disclosure.

FIG. 6 illustrates a flowchart providing a non-limiting exemplary process of operating a camera device according to various embodiments of the present disclosure.

Referring now to FIG. 6, at task 601, the sensor module 504 may output a detection signal corresponding to attachment or detachment of the lens module 501. For example, the attachment of the lens module 501 may push-in a switch, or may obstruct an optical sensor, etc. to detect the presence of the lens module. Other types of sensors may be used.

At task 603, the control module 506 may output a control signal in response to the detection signal. At task 605, the shutter module 502 may open or close the shutter in response to the control signal.

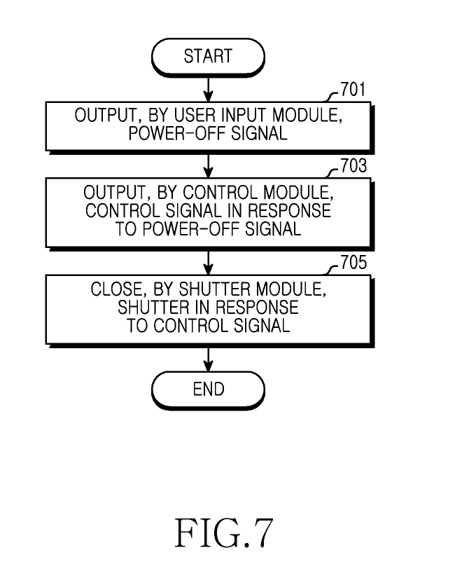

FIG. 7 illustrates another flowchart providing a non-limiting exemplary process of operating a camera device according to various embodiments of the present disclosure.

Referring now to FIG. 7, at task 701, the user input module 505 may output a power-off signal. At task 703, the control module 506 may output a control signal in response to the power-off signal. At task 705, the shutter module 502 may close the shutter in response to the control signal.

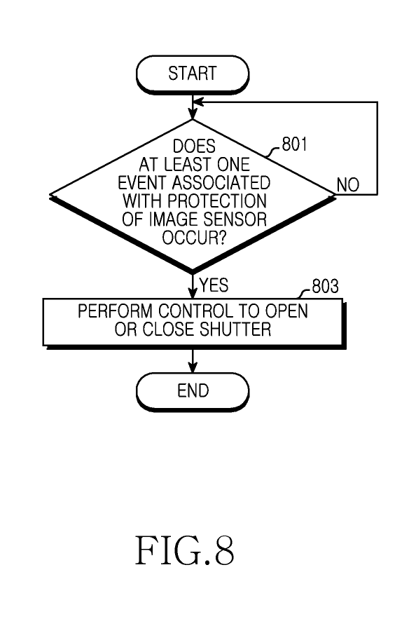

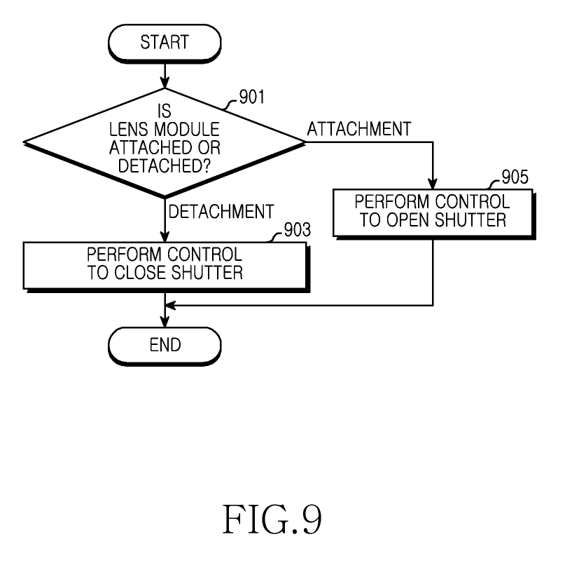

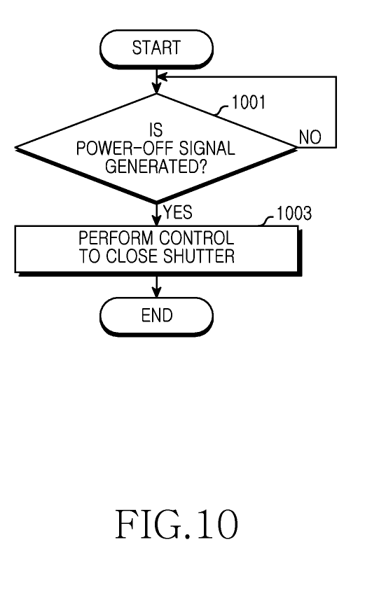

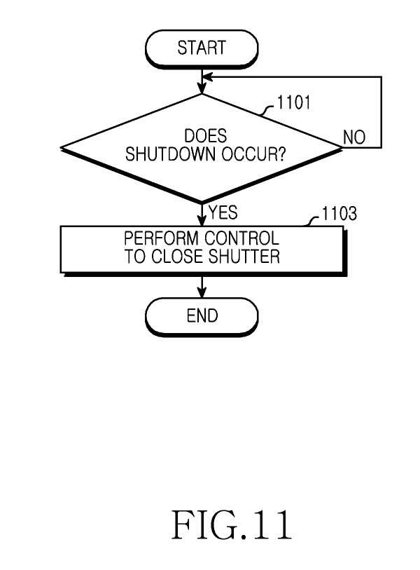

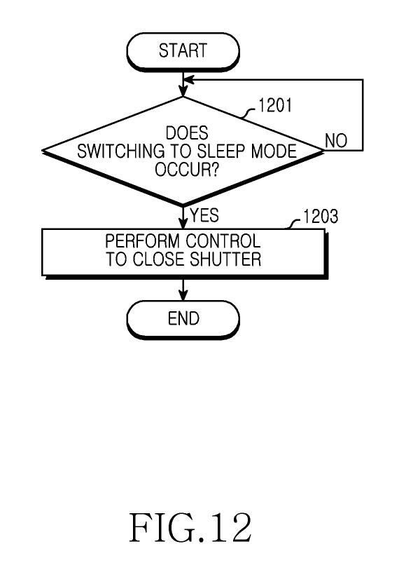

FIG. 8 illustrates another flowchart providing a non-limiting exemplary process of controlling a camera device according to various embodiments of the present disclosure.

Referring now to FIG. 8, at task 801, the control module 506 (for example, processor 110) identifies whether at least one event (for example, the attachment or detachment of the lens module, generation of the power-off signal, occurrence of shutdown, or switching to a sleep mode, etc.) associated with protection of an image sensor occurs. At task 803, the control module 506 (for example, processor 110) may perform a control operation to open or close a shutter.

FIG. 9 illustrates another flowchart providing a non-limiting exemplary process of controlling a camera device according to various embodiments of the present disclosure.

Referring now to FIG. 9, at task 901, the control module 506 (for example, the processor 110) may identify whether the lens module 501 (for example, the lens module 1910) is attached to or detached from the camera device. At task 903, the control module 506 (for example, processor 110) may perform a control operation to close the shutter in response to the detachment of the lens module 501. At task 905, the control module 506 (for example, processor 110) may perform a control operation to open the shutter in response to the attachment of the lens module 501.

There has been described the process of controlling the shutter in response to the attachment or detachment of the lens module 501. The present disclosure is not limited to the above configuration and another embodiment may be implemented with respect to other detachable electronic components (for example, the battery 196 or the memory 122).

FIG. 10 illustrates another flowchart providing a non-limiting exemplary process of controlling a camera device according to various embodiments of the present disclosure.

Referring now to FIG. 10, at task 1001, the control module 506 (for example, the processor 110) may identify whether a power-off signal is generated. In step 1003, the control module 506 (for example, processor 110) may perform a control operation to close a shutter in response to the generation of the power-off signal.

FIG. 11 illustrates another flowchart providing a non-limiting exemplary process of controlling a camera device according to various embodiments of the present disclosure.

Referring now to FIG. 11, at task 1101, the control module 506 (for example, the processor 110) may identify whether shutdown occurs. At task 1103, the control module 506 (for example, processor 110) may perform a control operation to close a shutter in response to the occurrence of the shutdown.

FIG. 12 illustrates another flowchart providing a non-limiting exemplary process of controlling a camera device according to various embodiments of the present disclosure.

Referring now to FIG. 12, at task 1201, the control module 506 (for example, the processor 110) may identify switching to a sleep mode. At task 1203, the control module 506 (for example, processor 110) may perform a control operation to close a shutter in response to the switching to the sleep mode.

In accordance with implementations of the present disclosure, a method for operating an electronic device including an image sensor for imaging includes: detecting at least one event associated with protection of the image sensor; and opening or closing a shutter in response to the at least one event, wherein a light guide of the image sensor is opened or closed depending on whether the shutter is opened or closed.

In accordance with implementations of the present disclosure, the at least one event may include sensing attachment or detachment of at least one component.

In accordance with implementations of the present disclosure, the at least one component may include a lens module including at least one lens.

In accordance with implementations of the present disclosure, opening or closing the shutter in response to the at least one event may include closing the shutter in response to detachment of the at least one component.

In accordance with implementations of the present disclosure, opening or closing the shutter in response to the at least one event may include opening the shutter in response to attachment of the at least one component.

In accordance with implementations of the present disclosure, the at least one event may include generation of a power-off signal, and opening or closing the shutter in response to the at least one event may include closing the shutter in response to the generation of the power-off signal.

In accordance with implementations of the present disclosure, the at least one event may include occurrence of shutdown, and opening or closing the shutter in response to the at least one event may include closing the shutter in response to the occurrence of the shutdown.

In accordance with implementations of the present disclosure, the at least one event may include switching to a sleep mode, and opening or closing the shutter in response to the at least one event may include closing the shutter in response to the switching to the sleep mode.

In accordance with implementations of the present disclosure, the at least one event may include detecting occurrence of an external shock to the electronic device, and opening or closing the shutter in response to the at least one event may include closing the shutter in response to the detected occurrence of the external shock.

In accordance with another implementations of the present disclosure, a method for operating an electronic device including an image sensor for imaging includes: outputting a detection signal corresponding to detachment of a lens module including at least one lens by a sensor module; outputting a control signal in response to the detection signal by a control module; and closing a shutter in response to the control signal by a shutter module.

In accordance with another implementation of the present disclosure, a method for operating an electronic device including an image sensor for imaging includes: outputting a power-off signal by a user input module; outputting a control signal in response to the power-off signal by a control module; and closing a shutter in response to the control signal by a shutter module.

The apparatuses and methods of the disclosure can be implemented in hardware, and in part as firmware or as software or computer code in conjunction with hardware that is stored on a non-transitory machine readable medium such as a CD ROM, a RAM, a floppy disk, a hard disk, or a magneto-optical disk, or computer code downloaded over a network originally stored on a remote recording medium or a non-transitory machine readable medium and stored on a local non-transitory recording medium for execution by hardware such as a processor, so that the methods described herein are loaded into hardware such as a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “processor”, “microprocessor” “controller”, or “control unit” constitute hardware in the claimed disclosure that contain circuitry that is configured for operation. Under the broadest reasonable interpretation, the appended claims constitute statutory subject matter in compliance with 35 U.S.C. §101.

The definition of the terms “unit” or “module” as referred to herein (such as the image module communication module 130, a sensor module 140, a user input module 150, a display module 160, an interface 170, an audio codec 180, a camera module 191, a power management module 195″ is to be understood as constituting hardware circuitry such as a CCD, CMOS, a processor or microprocessor configured for a certain desired functionality, or a communication module containing hardware such as transmitter, receiver or transceiver, or a non-transitory medium comprising machine executable code that is loaded into and executed by hardware for operation, in accordance with statutory subject matter under 35 U.S.C. §101 and do not constitute software per se.

When the methods are implemented by computer code loaded into hardware that is configured for operation, a computer-readable storage medium may be provided to store one or more programs (software modules).

These computer code may be stored in random access memories (RAMs), nonvolatile memories including flash memories, read only memories (ROMs), electrically erasable programmable ROMs (EEPROMs), magnetic disc storage devices, compact disk-ROMs (CD-ROMs), digital versatile disks (DVDs), other types of optical storage devices, or magnetic cassettes. Also, the computer code may be stored in a memory configured by a combination of some or all of such storage devices. Also, each of the memories may be provided with a plurality of the same.

Also, the computer code may be stored in an attachable storage device that may be accessed by the electronic device through a communication network such as Internet, Intranet, local area network (LAN), wireless LAN (WLAN), or storage area network (SAN), or through a communication network configured by a combination thereof. This storage device may be accessed by the electronic device through an external port. Also, a separate storage device on a communication network may be accessed a portable electronic device.

While the disclosure has been shown and described with reference to certain preferred embodiments thereof, it will be understood by those skilled in the art that various changes in form and details may be made therein without departing from the spirit and scope of the disclosure as defined by the appended claims. Therefore, the scope of the disclosure is defined not by the detailed description of the disclosure but by the appended claims, and all differences within the scope will be construed as being included in the present disclosure.

What is claimed is:

1. An electronic device, comprising:
a detachable lens module including at least one lens;
a shutter module disposed beneath the lens module and including an openable shutter;
an imaging module configured to convert light received through the lens module into an electrical signal, the imaging module being disposed beneath the shutter module;
a sensor module configured to detect whether the lens module is attached to or detached from the electronic device and output a detection signal in response thereto; and
a control module configured to output a control signal to the shutter module for opening or closing the shutter in response to the detection signal.

2. The electronic device of claim 1, wherein the control module outputs the control signal to the shutter module for closing the shutter in response to the detection signal indicating detachment of the lens module.

3. The electronic device of claim 1, wherein the control module outputs the control signal to the shutter module for opening the shutter, in response to the detection signal indicating attachment of the lens module.

4. The electronic device of claim 1, further comprising a housing defining an outer surface of the electronic device and including an opening,
wherein the opening is disposed in the housing between the lens module on the outer surface of the housing and the imaging module being within the housing, and the shutter module opens and closes a passage of the opening according to whether the shutter is opened or closed.

5. The electronic device of claim 1, wherein the sensor module includes a switch that is closed or open according to whether the lens module is attached or detached.

6. The electronic device of claim 1, wherein the sensor module is driven by a fully-functional level of operating power.

7. The electronic device of claim 6, wherein the control module switches from a sleep mode to a wake-up mode in response to receiving the detection signal.

8. The electronic device of claim 1, wherein the lens module further includes a diaphragm having a variably-sized diameter for regulating an amount of light.

9. An electronic device, comprising:
a lens module including at least one lens;
a shutter module disposed beneath the lens module and including an openable shutter;
an imaging module configured to convert light received through the lens module into an electrical signal, the imaging module being disposed beneath the shutter module; and
a control module configured to output a control signal to the shutter module for closing the shutter and performing a power-off operation, in response to a power-off signal.

10. A method for operating an electronic device including an image sensor for imaging, comprising:
detecting at least one event associated with protection of the image sensor; and
opening or closing a shutter in response to the detected at least one event,
wherein a light guide of the image sensor is opened or closed depending on whether the shutter is opened or closed.

11. The method of claim 10, wherein the detected at least one event includes detecting attachment to or detachment of at least one component to the electronic device.

12. The method of claim 10, wherein the detecting attachment of at least one component comprises a lens module including at least one lens.

13. The method of claim 10, wherein opening or closing the shutter in response to the detected at least one event comprises closing the shutter in response to detecting detachment of the at least one component from the electronic device.

14. The method of claim 10, wherein opening or closing the shutter in response to the detected at least one event comprises opening the shutter in response to detecting attachment of the at least one component to the electronic device.

15. The method of claim 10, wherein the detected at least one event includes detecting generation of a power-off signal, and opening or closing the shutter in response to the detected at least one event comprises closing the shutter in response to the generation of the power-off signal.

16. The method of claim 10, wherein the detected at least one event includes occurrence of a shutdown, and opening or closing the shutter in response to the detected at least one event comprises closing the shutter in response to the occurrence of the shutdown.

17. The method of claim 10, wherein the detected at least one event includes switching to a sleep mode, and opening or closing the shutter in response to the detected at least one event comprises closing the shutter in response to the switching to the sleep mode.

18. The method of claim 10, wherein the detected at least one event includes detecting occurrence of an external shock to the electronic device, and opening or closing the shutter in response to the detected at least one event comprises closing the shutter in response to the occurrence of the external shock.

19. A method for operating an electronic device including an image sensor for imaging, comprising:
outputting, by a sensor module, a detection signal indicating a detachment of a lens module from the electronic device;
outputting, by a control module, a control signal in response to the detection signal received from the sensor module; and
closing, by a shutter module, a shutter in response to the control signal.

20. A method for operating an electronic device including an image sensor for imaging, comprising:
outputting, by a user input module, a power-off signal;
outputting, by a control module, a control signal in response to receiving the power-off signal; and
closing, by a shutter module, a shutter in response to receiving the control signal.
